(19) United States
(12) Patent Application Publication
(10) Pub. No.: US 2018/0211009 A1
(43) Pub. Date: Jul. 26, 2018

(54) PREDICTING AN ADVERSE REACTION TO PHYSIOLOGICAL STRESS

(71) Applicant: International Business Machines Corporation, Armonk, NY (US)

(72) Inventors: Michael Bender, Rye Brook, NY (US); Gregory J. Boss, Saginaw, MI (US); Edward T. Childress, Austin, TX (US); Rhonda Childress, Austin, TX (US)

(21) Appl. No.: 15/412,249

(22) Filed: Jan. 23, 2017

(51) Int. Cl. G06F 19/00; G06N 5/04

(52) U.S. Cl. CPC G06F 19/345; G06N 5/04

(57) ABSTRACT

Embodiments of the invention provide a method, system and computer program product for predicting an adverse reaction to physiological stress. In one embodiment, the method detecting elevated levels of physiological stress experienced by an end user and logging a duration of the elevated levels of stress. Utilization data from one or more articles instrumented is received in connection with the end user and a time of utilization of the one or more articles logged. A correlation between the utilization of the one or more articles and the logged duration of elevated levels of stress is recorded in a data store. Finally, in response to a subsequent detection of an elevated level of physiological stress for a particular duration of time, a correlated utilization of the one or more articles is identified and a warning transmitted to the end user of a predicted utilization of the one or more articles.

### BACKGROUND OF THE INVENTION

### Field of the Invention

The present invention relates to stress detection and more particularly to managing an adverse reaction to a stress condition.

### Description of the Related Art

Stress is the reaction by the human body to a stimulus that disturbs the physical or mental equilibrium of the human body. Psychologically, a stressful event may trigger the “fight-or-flight” response, causing hormones such as adrenaline and cortisol to surge through the body. A small amount of stress, known as “acute stress,” can be exciting—it causes the individual experiencing acute stress to become active and alert. But, long-term, or “chronic stress,” can have detrimental effects upon one's health.

Each individual reacts differently to stress. Some adverse reactions to stress can lead to addictive behaviors, such as overeating, cigarette smoking or controlled substance abuse. Is is difficult to detect when one will experience stress, but measuring the duration of stress once experienced—particularly with respect to one who adversely reacts to stress with a destructive or addictive behavior—can enable the prevention of the adverse reaction in that person. Current methods to avoid an adverse reaction to stress include the individual responding to a bout with stress by logging facts associated with the onset of the feeling of stress so as to recognize what triggered the stress and the destructive behaviors caused by the stress. Consequently, the individual need only learn or retrain him or herself to engage in constructive rather than destructive behavior in response to the stress.

### BRIEF SUMMARY OF THE INVENTION

Embodiments of the present invention address deficiencies of the art in respect to stress detection and adverse reaction remediation and provide a novel and non-obvious method, system and computer program product for predicting an adverse reaction to physiological stress. In an embodiment of the invention, a method for predicting an adverse reaction to physiological stress includes detecting elevated levels of physiological stress experienced by an end user and logging a duration of the elevated levels of stress. The method also includes receiving utilization data from one or more articles instrumented in connection with the end user and logging a time of utilization of the one or more articles and recording in a data store a correlation between the utilization of the one or more articles and the logged duration of elevated levels of stress. Finally, the method includes responding to a subsequent detection of an elevated level of physiological stress for a particular duration of time by identifying a correlated utilization of the one or more articles and transmitting a warning to the end user of a predicted utilization of the one or more articles.

In one aspect of the embodiment, a correlation is recorded in the data store between a number of episodes of elevated levels of physiological stress and the utilization of the one or more articles. In another aspect of the embodiment, a correlation is recorded between an amount of time that has lapsed between a start of an episode of an elevated level of physiological stress and the utilization of the one or more articles. In yet another aspect of the embodiment, the articles include a cigarette case instrumented for communication over the global Internet. Finally, in even yet another aspect of the embodiment, the articles include dishware instrumented for communication over the global Internet.

In another embodiment of the invention, a data processing system is configured for predicting an adverse reaction to physiological stress. The system includes a host computing platform with one or more computers, each with memory and at least one processor. The host computing platform is communicatively linked to a stress monitor affixed to a person and also one or more personal articles instrumented in connection with the person. The system also includes an adverse reaction prediction module executing in the host computing platform. The module includes program code enabled during execution in the memory of the host computing platform to detect through the stress monitor elevated levels of physiological stress experienced by the person, log a duration of the elevated levels of stress, receive from the one or more personal articles utilization data in connection with the person, log a time of utilization of the one or more personal articles, record in a data store a correlation between the utilization of the one or more articles and the logged duration of elevated levels of stress, and respond to a subsequent detection of an elevated level of physiological stress for a particular duration of time by identifying a correlated utilization of the one or more articles and transmitting a warning to the person of a predicted utilization of the one or more articles.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for predicting an adverse reaction to physiological stress;

FIG. 2 is a schematic illustration of a data processing system configured for predicting an adverse reaction to physiological stress; and,

FIG. 3 is a flow chart illustrating a process for predicting an adverse reaction to physiological stress.

### DETAILED DESCRIPTION OF THE INVENTION

Embodiments of the invention provide for predicting an adverse reaction to physiological stress. In accordance with an embodiment of the invention, the degree of physiological stress experienced by an end user is measured over time by a measurement sensor affixed to the end user such as a smart watch or other personal health monitor. Periods of elevated physiological stress are then logged. As well, different IoT sensors report utilization by the end user of one or more corresponding instrumented personal articles, such as dishware, a utensil, a cup, mug or glass, or a cigarette case, and the utilization is logged as either an adverse reaction to physiological stress to the extent that the adverse reaction occurs concurrently with a logged period of elevated physiological stress, or a positive reaction to physiological stress to the extent that the positive reaction occurs in connection with a reduction of measured physiological stress during a logged period of elevated physiological stress.

A correlation is then determined as between the logged periods of stress and the adverse reaction and a reduction of measured physiological stress and the positive reaction. Thereafter, when an elevated period of stress is detected of a particular duration, a corresponding correlated adverse reaction is identified with respect to the end user, and a warning is presented to the end user, for instance in a display of the smart watch or personal health monitor, to undertake a remedial action so as to avoid the correlated adverse reaction to the detected period of stress. As well, a recommendation can be displayed in the warning to engage in the positive reaction previously correlated with a reduction in measured physiological stress.

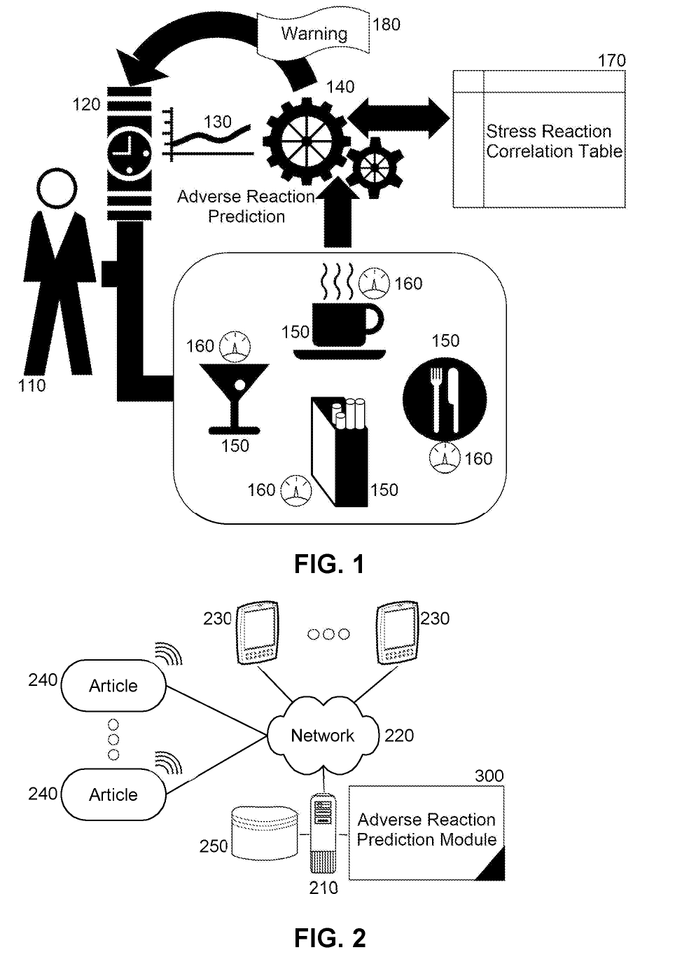

In further illustration, FIG. 1 pictorially illustrates a process for predicting an adverse reaction to physiological stress. As shown in FIG. 1, a stress monitor 120 adapted to measure a physiological condition of an end user such as blood pressure, pulse or perspiration, is affixed to the end user 110. The stress monitor 120 transmits to adverse reaction prediction logic 140, stress data 130 that may range from raw measurements to reduced analyzed data from the raw measurements. Concurrently, the adverse reaction prediction logic 140 receives utilization data from different personal articles 150 that have been instrumented with a sensor and communications circuitry 160 so as form part of the IoT.

Thereafter, the adverse reaction prediction logic 140 identifies a period of elevated stress based upon the stress data 140 and logs the stress data 130 in a stress reaction correlation table 170 in connection with observed adverse utilization of one or more of the articles by the end user 110, such as drinking from a glass, drinking from a mug or cup, eating from dishware with or without a utensil or opening a pack of cigarettes. In this regard, the adverse reaction prediction logic 140 may correlate the adverse utilization of one or more of the articles 150 by the end user 110 in connection with a particular duration of a stress event of elevated stress levels, or in connection with a lapsed period of time following the beginning of a stress event, or in connection with a number of stress events experienced by the end user 110, to name a few examples. As well, the adverse reaction prediction logic 140 may correlate the positive utilization of one or more others of the articles 150 by the end user 110 in connection with a reduction in levels of stress during a stress event of elevated stress levels—for example a treadmill, a pair of running shoes, a cup of tea, a music player, etc.

Consequently, upon detecting the inception of a stress event based upon the stress data 130 provided by the stress monitor 120, the adverse reaction prediction logic 140 may compare the characteristics of the stress event to different known utilizations of the articles 150 as evident in the stress reaction correlation table 170. Once a particular utilization of one of the articles 150 is located in the stress reaction correlation table 170 in respect to the stress event, the adverse reaction prediction logic 140 may transmit a warning 180 to the stress monitor 120 of the end user of a predicted adverse utilization of the one of the articles 150 along with a recommendation of a remedial activity intended to avoid the predicted adverse utilization of the one of the articles 150 in favor of a known positive utilization of another of the articles 150. Optionally, the recommended remedial activity may be initiated automatically, such as the playing back of music or the dimming of lights in a room

The process described in connection with FIG. 1 may be implemented in a data processing system. In yet further illustration, FIG. 2 schematically shows a data processing system configured for predicting an adverse reaction to physiological stress. The system includes a host computing platform 210 with one or more computers, each with memory and at least one processor. The host computing platform 210 is communicatively coupled over computer communications network 220 to different mobile devices 230, such as different smart phones, smart watches, health monitors, stress monitors and the like. The host computing platform 210 also is communicatively coupled over computer communications network 220 to different wirelessly transmitting personal articles 240 instrumented to report stress data as an IoT device.

An adverse reaction prediction module 300 executes in the memory of the host computing platform 210. The adverse reaction prediction module 300 includes program code enabled during execution in the memory of the host computing platform to collect utilization data from the articles 240 and also stress data from the mobile devices 230 in respect to different end users. The program code of the adverse reaction prediction module 300 then correlates in data store 250 the utilization data with the stress data for the different end users so as to identify when in response to a stress event each of the different end users utilizes one or more of the articles 240, both adversely and also positively. Finally, the program code of the adverse reaction prediction module 300 responds to the detection of a stress event for a particular one of the end users by locating in the data store 250 a correlated utilization of one of the articles 240 and presents a warning to the particular one of the end users as to the predictive, but undesirable utilization of the one of the articles 240 while suggesting a known positive utilization of one or more of the articles 240.

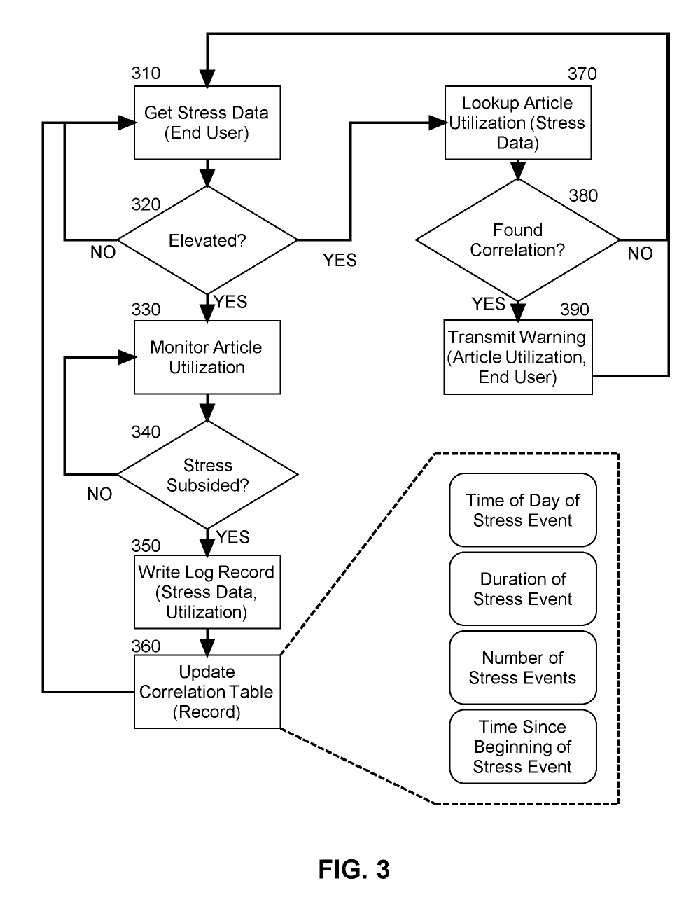

In even yet further illustration of the FIG. 3 is a flow chart illustrating a process for predicting an adverse reaction to physiological stress. Beginning in block 310, stress data is received in connection with an end user. In block 320, it is determined if the stress data is indicative of an elevated stress level beyond normally accepted levels for an end user of an age, weight and lifestyle profile of the end user. If so, in block 330 the utilization of one or more personal articles by the end user is monitored and recorded. In decision block 340, if the period of elevated stress is determined to have subsided, in block 350, a log record is written indicating the duration and time of the period of stress detected in consideration of the stress data for the end user, along with the utilization data of one or more articles by the end user.

In block 360, a correlation table is then updated so as to correlate characteristics of the observed period of stress with the monitored utilization of the articles by the end user. For instance, a time of day of the period of stress may be correlated with the use of a particular one of the articles by the end user. As another example, a duration of the stress event may be correlated with the use of a particular one of the articles by the end user. As yet another example, a number of stress events experienced by the end user may be correlated with the utilization by the end user of a particular one of the articles. Finally, in even yet another example, a time that has elapsed since the inception of a stress event may be correlated with the time when utilization of a particular one of the articles by the end user has commenced.

In any event, once the correlation table has been updated, the process may return to block 310 with the acquisition of additional stress data from the end user. Of note, whenever a period of elevated stress is detected in decision block 320, the correlation table may be accessed in block 370 so as to identify a correlation between the contemporaneously detected period of elevated stress and a previous utilization of a particular one of the articles by the end user. In decision block 380, if a correlation is located, in block 390 a warning may be transmitted to the end user alerting the end user as to the likelihood of the utilization of the particular one of the articles by the end user. The warning may also provide one or more recommended remedial measures intended to avoid the utilization of the particular one of the articles by the end user, such as previously observed behaviors known to have caused a reduction in measured stress levels.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for predicting an adverse reaction to physiological stress, the method comprising:
detecting elevated levels of physiological stress experienced by an end user;
logging a duration of the elevated levels of stress;
receiving utilization data from one or more articles instrumented in connection with the end user and logging a time of utilization of the one or more articles;
recording in a data store a correlation between the utilization of the one or more articles and the logged duration of elevated levels of stress; and,
responsive to a subsequent detection of an elevated level of physiological stress for a particular duration of time, identifying a correlated utilization of the one or more articles and transmitting a warning to the end user of a predicted utilization of the one or more articles.

2. The method of claim 1, wherein a correlation is recorded in the data store between a number of episodes of elevated levels of physiological stress and the utilization of the one or more articles.

3. The method of claim 1, wherein a correlation is recorded between an amount of time that has lapsed between a start of an episode of an elevated level of physiological stress and the utilization of the one or more articles.

4. The method of claim 1, wherein the one or more articles includes a cigarette case instrumented for communication over the global Internet.

5. The method of claim 1, wherein the one or more articles includes dishware instrumented for communication over the global Internet.

6. The method of claim 1, wherein the warning includes a recommendation to engage in an activity previously observed to cause a reduction in stress levels.

7. A data processing system configured for predicting an adverse reaction to physiological stress, the system comprising:
a host computing platform comprising one or more computers, each with memory and at least one processor, and being communicatively linked to a stress monitor affixed to a person and also one or more personal articles instrumented in connection with the person; and,
an adverse reaction prediction module executing in the host computing platform, the module comprising program code enabled during execution in the memory of the host computing platform to detect through the stress monitor elevated levels of physiological stress experienced by the person, log a duration of the elevated levels of stress, receive from the one or more personal articles utilization data in connection with the person, log a time of utilization of the one or more personal articles, record in a data store a correlation between the utilization of the one or more articles and the logged duration of elevated levels of stress, and respond to a subsequent detection of an elevated level of physiological stress for a particular duration of time by identifying a correlated utilization of the one or more articles and transmitting a warning to the person of a predicted utilization of the one or more articles.

8. The system of claim 7, wherein a correlation is recorded in the data store between a number of episodes of elevated levels of physiological stress and the utilization of the one or more articles.

9. The system of claim 7, wherein a correlation is recorded between an amount of time that has lapsed between a start of an episode of an elevated level of physiological stress and the utilization of the one or more articles.

10. The system of claim 7, wherein the one or more articles includes a cigarette case instrumented for communication over the global Internet.

11. The system of claim 7, wherein the one or more articles includes dishware instrumented for communication over the global Internet.

12. The system of claim 7, wherein the warning includes a recommendation to engage in an activity previously observed to cause a reduction in stress levels.

13. A computer program product for predicting an adverse reaction to physiological stress, the computer program product comprising a computer readable storage medium having program instructions embodied therewith, the program instructions executable by a device to cause the device to perform a method comprising:
detecting elevated levels of physiological stress experienced by an end user;
logging a duration of the elevated levels of stress;
receiving utilization data from one or more articles instrumented in connection with the end user and logging a time of utilization of the articles;
recording in a data store a correlation between the utilization of the one or more articles and the logged duration of elevated levels of stress; and,
responsive to a subsequent detection of an elevated level of physiological stress for a particular duration of time, identifying a correlated utilization of the one or more articles and transmitting a warning to the end user of a predicted utilization of the one or more articles.

14. The computer program product of claim 13, wherein a correlation is recorded in the data store between a number of episodes of elevated levels of physiological stress and the utilization of the one or more articles.

15. The computer program product of claim 13, wherein a correlation is recorded between an amount of time that has lapsed between a start of an episode of an elevated level of physiological stress and the utilization of the one or more articles.

16. The computer program product of claim 13, wherein the one or more articles includes a cigarette case instrumented for communication over the global Internet.

17. The computer program product of claim 13, wherein the one or more articles includes dishware instrumented for communication over the global Internet.

18. The computer program product of claim 13, wherein the warning includes a recommendation to engage in an activity previously observed to cause a reduction in stress levels.
